(19) United States
(12) Patent Application Publication
(10) Pub. No.: US 2009/0142039 A1
(43) Pub. Date: Jun. 4, 2009

(54) METHOD AND APPARATUS FOR RECORDING VIDEO DATA

(75) Inventor: Si Young PARK, Sungnam-si (KR)

Correspondence Address: KED & ASSOCIATES, LLP, P.O. Box 221200, Chantilly, VA, 20153-1200, US

(73) Assignee: HUMAX Co., Ltd.

(21) Appl. No.: 12/323,074

(22) Filed: Nov. 25, 2008

Related U.S. Application Data
(63) Continuation-in-part of application No. 11/019,646, filed on Dec. 23, 2004, now abandoned.

(30) Foreign Application Priority Data
Dec. 26, 2003 (KR) 03-97513

(51) Int. Cl. H04N 7/26; H04N 5/91

(52) U.S. Cl. 386/109; 386/131

(57) ABSTRACT

The present invention relates to a method and apparatus for recording video data. The method for recording video data in accordance with an embodiment of the present invention includes displaying a plurality of still images having different qualities along with quality information on each still image on a screen, and if a still image is selected from among the plurality of still images displayed on the screen, recording input video data at a quality corresponding to the selected still image. Therefore, a user easily compares video-data qualities according to a plurality of recording qualities with one another, and correctly selects a desired recording quality from among the plurality of recording qualities.

### BACKGROUND OF THE INVENTION

1. Field of the Invention

The present invention relates to a method and apparatus for recording video data, and more particularly to a method and apparatus for allowing a user to record video data at a desired recording quality in a digital recording device such as a DVD-recorder or an HDD-recorder.

2. Description of the Related Art

In recent times, digital recording device such as a DVD-recorder or an HDD-recorder have been newly developed and made commercially available. A user of the digital recording device can store and reproduce high-quality video data streams and high-quality audio data streams in an optical disc or an HDD.

The digital recording device such as a DVD-recorder includes an optical pickup unit 11, a Video Disc Recording (VDR) system 12, a menu graphic generator 13, a microprocessor 14, and a memory 15, etc., as shown in FIG. 1.

If an optical disc 10 such as a DVD-RW is seated in the digital recording device, the microprocessor 14 reads navigation information recorded in a Lead-In area of the optical disc 10, and stores the read navigation information in the memory 15.

The microprocessor 14 refers to the navigation information stored in the memory 15 upon receipt of a request from a user, and controls the VDR system 12, such that it reproduces video and audio data recorded in a data area of the optical disc 10 or records video and audio data received from an external part in the data area of the optical disc 10.

If the microprocessor 14 records data in the optical disc 10 upon receipt of a request from a user, it controls the VDR system 12, such that video or audio data is encoded at a user-selected recording quality and is recorded in the optical disc 10.

For example, if the recording quality is set to High Quality (HQ) according to a control signal of the microprocessor 14, the VDR system 12 encodes video data at a bit rate of 9.72 Mbits/sec, and encodes audio data at a bit rate of 384 Kbits/sec, such that it records high-quality video data and high-quality audio data therein. If the recording quality is set to Standard Quality (SQ), the VDR system 12 encodes video data at a bit rate of 5.07 Mbits/sec, and encodes audio data at a bit rate of 256 Kbits/sec, such that it records standard-quality video data and standard-quality audio data therein. If the recording quality is set to Low Quality (LQ), the VDR system 12 encodes video data at a bit rate of 3.38 Mbits/sec, and encodes audio data at a bit rate of 256 Kbits/sec, such that it records low-quality video data and standard-quality audio data therein. If the recording quality is set to Extension Quality (EQ), the VDR system 12 encodes video data at a bit rate of 2.54 Mbits/sec, and encodes audio data at a bit rate of 256 Kbits/sec, such that it records the lowest-quality video data and standard-quality audio data therein.

Therefore, the user of the above-mentioned digital recording device such as a DVD-recorder sets a desired recording quality to an HQ mode, such that high-quality video data and high-quality audio data are recorded in the digital recording device. Otherwise, the user of the digital recording device sets a desired recording quality to the EQ mode, such that the lowest-quality video data and standard-quality audio data can be recorded in the digital recording device during a long period of time.

However, conventional digital recording devices do not allow the user to directly compare video-data qualities corresponding to individual recording qualities of HQ, SQ, LQ, and EQ modes with one another. Therefore, the user may unexpectedly record video and/or audio data in the digital recording device at undesired quality. Also, in order to allow the user to recognize video-data qualities corresponding to individual recording qualities, the digital recording device must separately reproduce a plurality of video data units pre-recorded according to individual recording qualities.

### SUMMARY OF THE INVENTION

Therefore, the present invention has been made in view of the above problems, and it is an object of the present invention to provide a method for allowing a user to correctly select a desired recording quality from among a plurality of recording qualities in a variety of digital recording device such as DVD-recorders or HDD-recorders.

It is another object of the present invention to provide a method for allowing a user to easily compare video-data qualities corresponding to individual recording qualities with one another in a digital recording device.

In accordance with an aspect of the present invention, the above and other objects can be accomplished by a method for recording video data comprising the steps of: displaying a plurality of still images having different qualities along with quality information on each still image on a screen; and, if a still image is selected from among the plurality of still images displayed on the screen, recording input video data at a quality corresponding to the selected still image.

In accordance with another aspect of the present invention, there is provided an apparatus for recording video data comprising: a memory for storing a plurality of still images having different qualities; a screen generator for generating and outputting a screen image for the plurality of still images stored in the memory and adding quality information on each still image; a converter for converting input video data; a recorder for recording converted data output from the converter in a recording medium; and a controller for controlling the converter and the recorder such that, if a user selects a still image from the plurality of still images output from the screen generator, the converter recognizes a quality corresponding to the selected still image and converts the input video data at the recognized quality, and the recorder records the converted video data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional digital recording device;

FIG. 2 is a block diagram illustrating a digital recording device according to the present invention;

FIG. 3 is a flow chart illustrating a method for establishing a recording quality in a digital recording device in accordance with a preferred embodiment of the present invention;

FIG. 4 is an exemplary view illustrating a menu image for use in a recording quality setup mode displayed on a screen in accordance with a preferred embodiment of the present invention;

FIG. 5 is a flow chart illustrating a method for establishing a recording quality in a digital recording device in accordance with another preferred embodiment of the present invention;

FIG. 6 is an exemplary view illustrating a menu image for use in a recording quality setup mode displayed on a screen in accordance with another preferred embodiment of the present invention;

FIG. 7 is a diagram illustrating an example in which a plurality of still images having different qualities are displayed on a screen such that a user can select a recording quality in the case where the aspect ratio of input video data is 4:3;

FIG. 8 is a diagram illustrating another example in which a plurality of still images having different qualities are displayed on a screen such that a user can select a recording quality in the case where the aspect ratio of input video data is 16:9;

FIG. 9 is a diagram illustrating still another example in which a plurality of still images having different qualities are displayed on a screen such that a user can select a recording quality in the case where the aspect ratio of input video data is 4:3;

FIG. 10 is a diagram illustrating an example in which a plurality of still images each having a different quality are sequentially displayed on a screen such that a user can select a recording quality; and

FIG. 11 is diagram illustrating an example of a screen for setting a conversion format applied to the conversion of video data after a quality of a still image is selected.

### DETAILED DESCRIPTION OF PREFFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

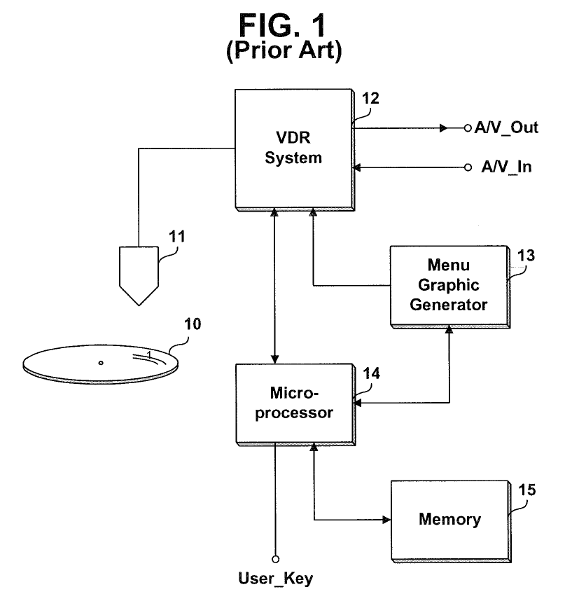

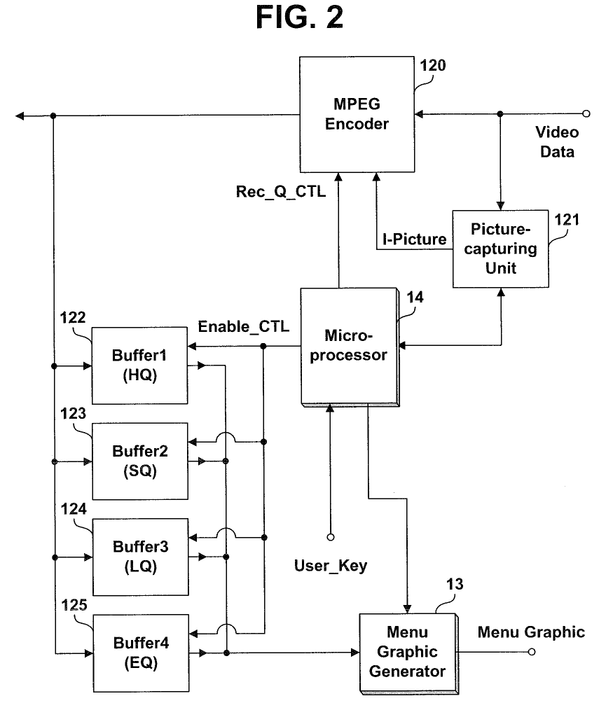

The method for establishing a recording quality according to the present invention is applicable to a variety of digital recording devices such as HDD-recorders or DVD-recorders. For example, a DVD-recorder according to the present invention includes an optical pick unit 11, a VDR system 12, a menu graphic generator 13, a microprocessor 14, and a memory 15, etc., as shown in FIG. 1. The VDR system 12 may include an MPEG encoder 120, a picture-capturing unit 121, and first to fourth buffers 122, 123, 124, and 125, as shown in FIG. 2.

The microprocessor 13 controls the picture-capturing unit 121 when a user selects a desired recording quality, captures one Intra-Picture (I-Picture) from among input video data streams, and controls the MPEG decoder 120, such that the captured I-picture is differently encoded at HQ, SQ, LQ, and EQ recording qualities.

The microprocessor 14 selectively enables the first to fourth buffers 122, 123, 124, and 125, stores the encoded HQ/SQ/LQ/EQ still images in the first, second, third and fourth buffers 122, 123, 124, and 125, respectively, and controls the menu graphic generator 13, such that it displays HQ/SQ/LQ/EQ still images on a menu image on which a user can select a desired recording quality. In this case, information associated with individual recording times of HQ/SQ/LQ/EQ recording qualities, for example, recording-time ratio information (Rec_time_ratio), is displayed on the menu screen in association with the HQ/SQ/LQ/EQ recording qualities.

Therefore, the user can easily compare video-data qualities in response to individual recording qualities with one another, and can correctly select a desired recording quality. A detailed description associated with the above-mentioned operation will hereinafter be described with reference to the annexed drawings.

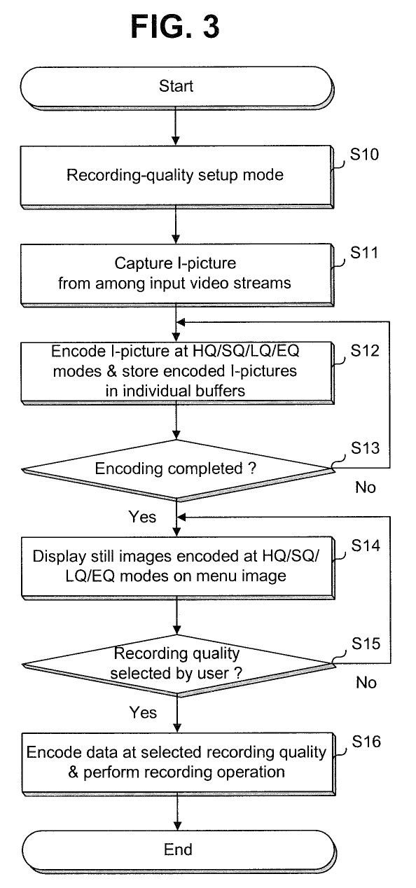

FIG. 3 is a flow chart illustrating a method for establishing a recording quality in a digital recording device in accordance with a preferred embodiment of the present invention. If a user requests a recording-quality setup mode at step S10, the microprocessor 14 controls the picture-capturing unit 121 to capture one picture from among input video data streams, for example, an I-picture at step S11.

The microprocessor 14 controls the MPEG decoder 120 to differently encode the I-picture captured by the picture-capturing unit 121 according to HQ/SQ/LQ/EQ recording qualities, and sequentially enables the first to fourth buffers 122, 123, 124 and 125, such that a still image encoded at the HQ recording quality is stored in the first buffer 122, a still image encoded at the SQ recording quality is stored in the second buffer 123, a still image encoded at the LQ recording quality is stored in the third buffer 124, and a still image encoded at the EQ recording quality is stored in the fourth buffer 125 at step S12.

If the encoding operations at the HQ/SQ/LQ/EQ recording qualities have been completed at step S13, the microprocessor 14 controls the menu graphic generator 13, such that it displays still images stored in the first to fourth buffers 122, 123, 124 and 125 on the recording-quality selection menu image at step S14.

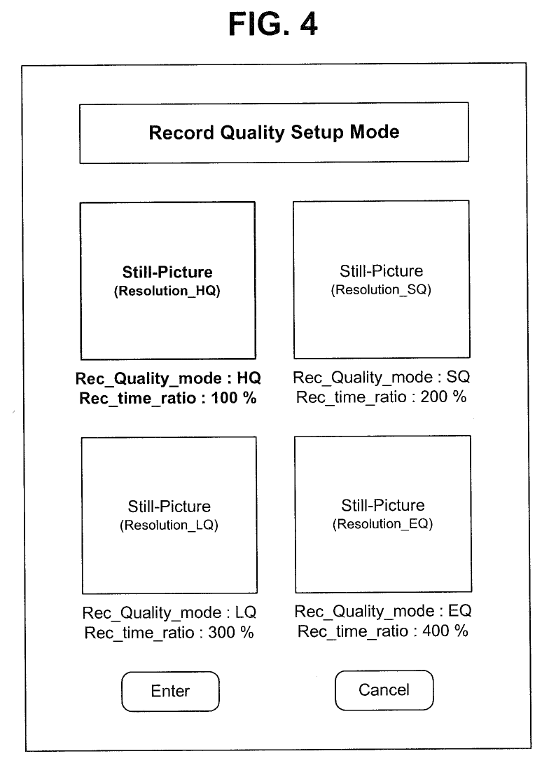

For example, a plurality of still images encoded at HQ/SQ/LQ/EQ recording qualities are displayed in the form of prescribed sizes on the recording-quality selection menu image shown in FIG. 4, and a relative recording-time ratio (Rec_time_ratio) in response to each recording quality is also displayed on each still image. In the case of the HQ recording quality, a recording-time ratio is determined to be 100%. In the case of the SQ recording quality, a recording-time ratio is determined to be 200%. In the case of the LQ recording quality, a recording-time ratio is determined to be 300%. In the case of the EQ recording quality, a recording-time ratio is determined to be 400%. The above-mentioned recording-quality time ratios can be displayed along with still images for every recording quality.

A cursor for allowing a user to select a corresponding recording quality may overlap with one still image displayed on the recording-quality selection menu image. For example, if a user desires to record high-quality video data, the user selects a still image of the HQ recording quality. If the user desires to record the lowest-quality video data for a long period of time, the user selects a still image of the EQ recording quality.

If the user selects one of the recording qualities using the above-mentioned process at step S15, the microprocessor 14 encodes and records input video data and input audio data at the user-selected recording quality at step S16. For example, if the user selects an HQ recording quality from among a plurality of recording qualities, the microprocessor 14 controls the MPEG encoder 120 to encode input video data at a bit rate of 9.72 Mbits/sec and to encode input audio data at a bit rate of 384 Kbits/sec, such that the recording of high-quality video data and high-quality video data is implemented. Otherwise, if the user selects an EQ recording quality, the microprocessor 14 controls the MPEG encoder 120 to encode input video data at a bit rate of 2.54 Mbits/sec and to encode input audio data at a bit rate of 256 Kbits/sec, such that the recording of the lowest-quality video data and standard-quality video data is implemented.

Therefore, the user can easily compare video-data qualities associated with individual recording qualities with one another, and can correctly select a desired recording quality from among a plurality of recording qualities.

In accordance with another preferred embodiment of the present invention, a recording-quality setup method does not use the picture-capturing unit 121 and the first to fourth buffers 122, 123, 124 and 125. If a user requests a recording-quality setup mode on the condition that a plurality of sample images corresponding to HQ/SQ/LQ/EQ recording qualities have been stored in the memory 15, the recording-quality setup method reads the sample images from the memory 15, and displays the read sample images on the recording-quality selection menu image. A detailed description associated with the above-mentioned operation will hereinafter be described with reference to the annexed drawings.

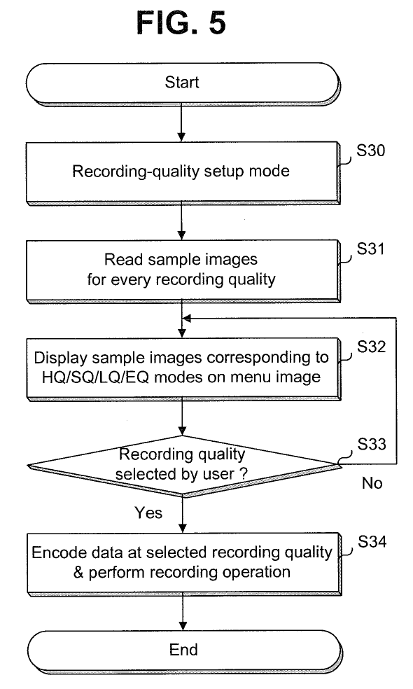

FIG. 5 is a flow chart illustrating a method for establishing a recording quality in a digital recording device in accordance with another preferred embodiment of the present invention. Referring to FIG. 5, if a user requests a recording-quality setup mode at step S30, the microprocessor 14 reads sample images having HQ/SQ/LQ/EQ recording qualities from the memory 15 at step S31.

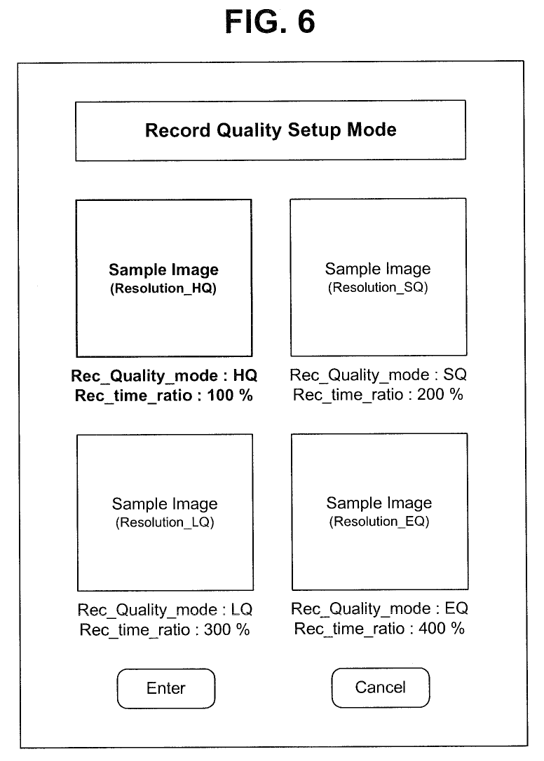

The microprocessor 14 controls the menu graphic generator 13 such that the read sample images can be displayed on the recording-quality selection menu image at step S32. For example, individual sample images of HQ/SQ/LQ/EQ recording qualities are displayed in the form of prescribed sizes on the recording-quality selection menu image shown in FIG. 6, and a relative recording-time ratio (Rec_time_ratio) in response to each recording quality is also displayed on each sample image. Also, a cursor for allowing a user to select a corresponding recording quality may overlap with one sample image displayed on the recording-quality selection menu image.

If a user selects one recording quality from among a plurality of recording qualities at step S33, the microprocessor 14 encodes and records input video data and input audio data at the user-selected recording quality at step S34.

Recently, portable reproducing devices for reproducing encoded moving picture data such as MP3 players, electronic dictionaries, mobile phones, portable multimedia players (PMP), etc. have been popularized. Image data recorded in an optical disc, a hard disc or a flash memory of a digital recording device can be reproduced and further can be transmitted to another device and reproduced.

In the case of a personal computer (PC), since applications including a variety of codecs may be installed free of charge therein and the resolution of a monitor or the data processing capability of the computer is sufficient, there is no difficulty in reproducing the moving picture data transmitted from the digital recording device.

However, since the portable reproducing device has limitations such as small screen size, low resolution, and low data processing capability and the number of codecs to be processed is limited, it may not reproduce the moving picture data encoded and transmitted from the digital recording device.

In this case, it is necessary to transcode the encoded moving picture data into another codec so as to reproduce the moving picture data in the portable reproducing device. However, the transcoding operation requires lots of time and effort.

Therefore, another preferred embodiment of the present invention provides a method for selecting a conversion quality when converting and recording video data input to the digital recording device on a recording medium so that the converted video data transmitted from the digital recording medium can be reproduced in a reproducing device that the user uses such as the portable reproducing device having some limitations in reproducing video data.

Since the portable reproducing device has limitations in resolution on the screen, a video data recording apparatus to which the present invention is applied captures an Intra-Picture (I-Picture) from the input video data, encodes the captured the I-Picture at a plurality of qualities, i.e., at different resolutions of various sizes, and stores the encoded images in individual buffers (or encodes the captured still image at different resolutions, decodes the encoded images, and stores the decoded images in individual buffers), such that a plurality of still images having different resolutions may be displayed on a recording-quality selection menu image.

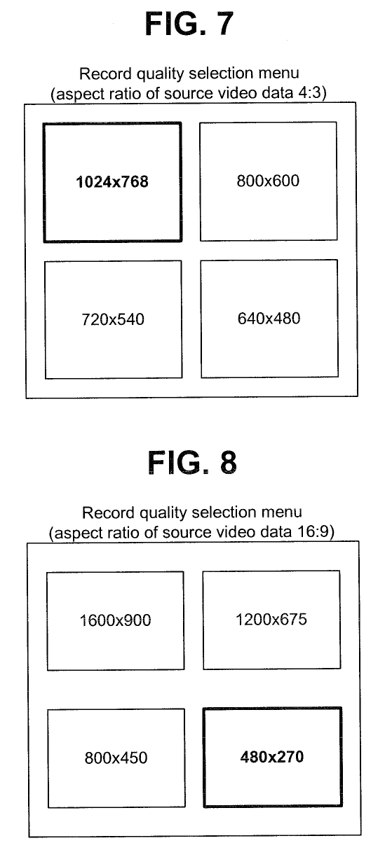

FIGS. 7 to 9 show examples of a plurality of still images having different resolutions displayed on a screen so that a user can compare recording qualities of the still images with one another and select a desired recording resolution.

In this case, the video data recording apparatus in accordance with the present invention may generate a plurality of sample still images each resolution being proportional to an aspect ratio of the captured I-Picture, where the generation may include encoding the sample still images at corresponding resolutions and decoding the same.

For example, if the aspect ratio of input video data is 4:3 and the resolution is equal to or greater than 1024×768, the recording apparatus may generate a plurality of still images having resolutions of 1024×768, 800×600, 720×540, and 640×480, and display the still images on the same screen. For example, if the aspect ratio of input video data is 16:9 and the resolution is equal to or greater than 1600×900, the recording apparatus may generate a plurality of still images having resolutions of 1600×900, 1200×675, 800×450, and 480×270, and may display the still images on the same screen.

Of course, the recording apparatus may generate a plurality of still images having resolutions corresponding to an aspect ratio different from the aspect ratio of the input video data upon receipt of a request from a user. For example, if the aspect ratio of the user's portable reproducing device is 4:3, the user can set the recording apparatus to generate a plurality of still images having resolutions corresponding to 4:3, even if the aspect ratio of the input video data is not 4:3 but 16:9.

Otherwise, the recording apparatus may display a plurality of still images having resolutions corresponding to the aspect ratio of the input video data on the screen and, at the same time, outputs an item for changing the aspect ratio on the same screen, such that the user can select a desired aspect ratio.

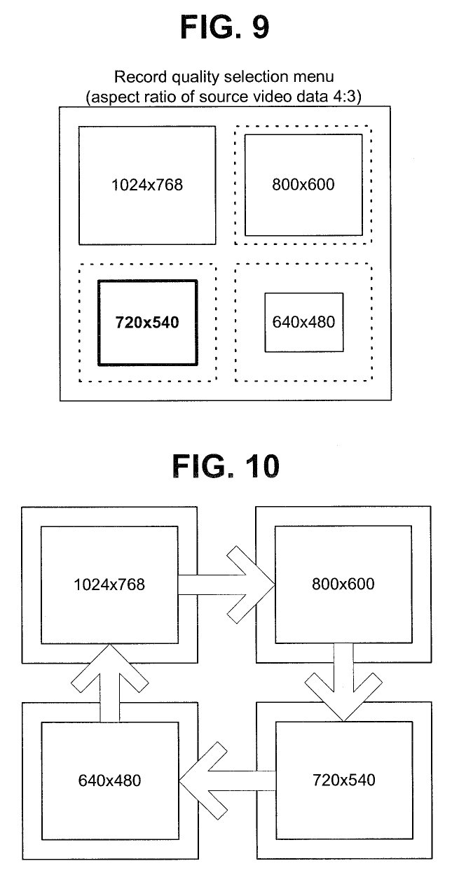

In this case, as shown in FIGS. 7 and 8, the recording apparatus displays the still images having different resolutions on the same screen in the same size. Otherwise, as shown in FIG. 9, the recording apparatus may adjust the sizes of still images having different resolutions to be relative to the size of the still image having the highest resolution, and may display the adjusted still images on the same screen. In the latter case, a box corresponding to the size of the still image having the highest resolution is arranged at the rear of each of the still images having lower resolutions, such that the user can intuitively compare the individual still images with one another.

In order to display a plurality of still images on the same screen, it is necessary to display the plurality of still images at resolutions lower than the resolution of each still image and, thus, the user may not distinguish the difference in resolutions of the plurality of still images displayed on the same screen. The recording apparatus of the present invention displays the plurality of still images generated at different resolutions and stored therein on the same screen; instead, it may sequentially display the plurality of still images on the screen one by one in a circulated manner, as shown in FIG. 10.

Even in this case, the recording apparatus may display a still image having a low resolution on the entire screen or may display the still image having a low resolution in a size relative to the size of the still image having the highest resolution on the same screen. In the former case, since artifacts between individual pixels of the still image are seen prominently, the quality of the image can be easily recognized. In the latter case, although the size of the image is reduced and thus these artifacts are not seen well, the size of the image can be intuitively understood.

Meanwhile, the moving picture data or video data comprises a plurality of still images, and the factors that determine the conversion quality of the moving picture data include a frame rate, a quality degree, and a conversion method as well as the resolutions of the still images.

The frame rate indicates the number of still images to Be encoded per unit time and, for example, 30 frames, 24 frames, 15 frames, or 7.5 frames per second may be displayed on the menu screen, otherwise, the user can directly input the frame rate.

The quality degree is an item related to a quantization degree or a bit resolution of individual pixels. If the quality is set to low, the bit rate of generated data is reduced; however, color or brightness between the pixels is not distinguished. On the contrary, if the quality is set to high, the color and the brightness between the pixels are clearly distinguished; however, the bit rate is increased.

The conversion method is a codec applied to the conversion of video data, and may include Dvix, Xvid, MPEG-2, MPEG-4, WMV, H.264, DV, etc.

In the case of video data representing a landscape having small change between frames, it is advantageous to increase the resolution, even if the frame rate is reduced. In the case of video data representing a sport having large change between frames, it is advantageous to increase the frame rate, even if the resolution is reduced. Therefore, it is preferable to allow the user to determine conversion quality factors according to the theme of the input video data.

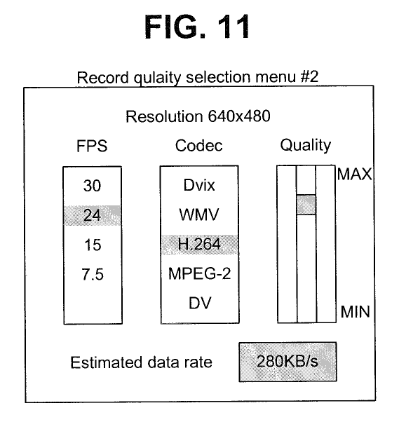

Therefore, if the conversion resolution of the input video data is determined through the menu screens of FIGS. 7 to 10, the video data recording apparatus in accordance with the present invention may display a menu screen for setting a conversion format such as the frame rate, the quality degree, and the conversion method, such that the user can determine a desired conversion quality for each item, as shown in FIG. 11. An item for changing the aspect ratio or the conversion resolution may be further included in the menu screen for setting the conversion format of FIG. 11.

Moreover, the video data recording apparatus in accordance with the present invention may estimate the bit rate of converted data, i.e., the amount of data generated per unit time, based on the values of individual items that the user determines through the menu screens of FIGS. 7 to 11, and may display the estimated bit rate on the menu screen of FIG. 11. Furthermore, in the case where the duration of the input video data is confirmed, for example by EPG, the video data recording apparatus may estimate an overall capacity of the converted data based on the resolution, the frame rate, the conversion method, the quality degree item, and the duration of the input video data, and may display the estimated capacity on the menu screen.

The user can set the conversion format through the menu screens of FIGS. 7 to 11 in view of the screen size or resolution, the kinds of codecs, and the data processing capability of the portable reproducing device, and can compare the storage capacity of the reproducing device with the overall capacity of the converted data which are displayed on the menu screen, thus changing the conversion format.

Therefore, it is possible to immediately reproduce the video data, encoded and recorded in the video data recording apparatus, in the reproducing device without transcoding.

As apparent from the above description, the present invention allows a user to correctly select a desired recording quality from among a plurality of recording qualities.

Also, the present invention allows the user to easily compare video-data qualities in response to individual recording qualities with one another.

Moreover, according to the present invention, the moving picture data can be converted and recorded in a video data recording apparatus so as to be immediately reproduced in a reproducing apparatus without transcoding.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for recording video data, comprising the steps of:
displaying a plurality of still images having different qualities along with quality information on each still image on a screen; and
if a still image is selected from among the plurality of still images displayed on the screen, recording input video data at a quality corresponding to the selected still image.

2. The method according to claim 1, wherein the displaying step displays the plurality of still images on one screen or sequentially displays the plurality of still images one by one on the screen.

3. The method according to claim 1, wherein the quality information is resolution information on each still image.

4. The method according to claim 1, wherein the recording step further comprises the step of:
displaying a menu screen for setting a conversion format to be applied to conversion of the input video data, if the still image is selected.

5. The method according to claim 4, wherein the conversion format comprises at least one among an aspect ratio, a frame rate, a conversion method, and a conversion quality degree.

6. The method according to claim 5, wherein the menu screen displaying step further comprises the step of:
displaying an estimated value of a converted data rate calculated based on the quality information on the still image and the set conversion format.

7. The method according to claim 5, wherein the menu screen displaying step further comprises the step of:
displaying an estimated value of an overall capacity of converted data calculated based on the quality information on the still image, the set conversion format, and duration information on the input video data.

8. The method according to claim 1, wherein the recording step further comprises the step of:
displaying a plurality of still images generated by applying different screen effects to the selected still image.

9. The method according to claim 8, wherein the screen effect comprises at least one among a black and white mode, a sepia mode, a mosaic mode, and a sketch mode.

10. The method according to claim 1, wherein the displaying step further comprises the step of:
capturing an Intra-Picture (I-Picture) from the input video data and converting the captured I-Picture into a plurality of still images having different qualities.

11. The method according to claim 10, wherein the converting step converts the captured I-Picture into a plurality of still images each having resolutions proportional to an aspect ratio of the I-Picture.

12. The method according to claim 1, wherein the displaying step further comprises the step of:
reading the plurality of still images converted at different qualities and pre-stored in a video data recording apparatus.

13. A video data recording apparatus comprising:
a memory for storing a plurality of still images having different qualities;
a screen generator for generating and outputting a screen image for the plurality of still images stored in the memory and adding quality information on each still image;
a converter for converting input video data;
a recorder for recording converted data output from the converter in a recording medium; and
a controller for controlling the converter and the recorder such that, if a user selects a still image from the plurality of still images output from the screen generator, the converter recognizes a quality corresponding to the selected still image and converts the input video data at the recognized quality, and the recorder records the converted video data.

14. The apparatus according to claim 13, wherein the screen generator generates the plurality of still images and outputs the plurality of still images into one screen image or sequentially outputs the plurality of still images one by one.

15. The apparatus according to claim 13, wherein the screen generator adds resolution information of each still image as the quality information.

16. The apparatus according to claim 13, wherein, if a user selects a still image, the controller controls the screen generator to generate and output a menu screen for setting a conversion format applied to the conversion of the input video data.

17. The apparatus according to claim 16, wherein the conversion format comprises at least one among an aspect ratio, a frame rate, a conversion method, and a conversion quality degree.

18. The apparatus according to claim 17, wherein the controller calculates an estimated value of a converted data rate based on the quality information on the still image and the set conversion format or calculates an estimated value of an overall capacity of the converted data based on the quality information on the still image, the set conversion format, and duration information on the input video data, and controls the screen generator such that the calculated value is included in the menu screen.

19. The apparatus according to claim 13, wherein the controller controls the converter to capture an Intra-Picture (I-Picture) from the input video data, to convert the captured I-Picture into a plurality of still images having different qualities, and to store the converted still images in the memory.

20. The apparatus according to claim 19, wherein the converter converts the captured I-Picture into a plurality of still images each having resolution proportional to an aspect ratio of the I-Picture.
